(19) United States
(12) Patent Application Publication
(10) Pub. No.: US 2012/0278308 A1
(43) Pub. Date: Nov. 1, 2012

(54) CUSTOM SEARCH QUERY SUGGESTION TOOLS

(75) Inventor: Xin Zhou, Beijing (CN)

(73) Assignee: GOOGLE INC., Mountain View, CA (US)

(21) Appl. No.: 13/517,236

(22) PCT Filed: Dec. 30, 2009
(86) PCT No.: PCT/CN2009/001582

§ 371 Date: Jun. 19, 2012

(51) Int. Cl. G06F 17/30

(52) U.S. Cl. 707/715; 707/E17.017

(57) ABSTRACT

Methods, systems, and apparatus, including computer program products, for generating search query suggestions directed to a particular website. In one aspect, a method includes receiving a first set of suggestion data defining custom suggestions for a first website. The first set of suggestion data includes one or more first n grams and one or more second n grams that each represent a selectable alternative to a first n gram. The method also includes generating a suggestion resource and providing a search query suggestion tool to the first website, the suggestion tool being configured to generate a search query input field for webpages on the first website, receive a query input entered in the search query input field, and request that one or more query suggestions be provided as selectable alternatives to the search query input.

### BACKGROUND

This specification relates to digital data processing, and in particular, to computer-implemented search services.

Conventional search services provide search query suggestions as alternatives to input search queries. For example, a webpage can include a search query input field that receives an input search query. In response to receiving the input search query, a conventional search service can provide search query suggestions for the input search query. A user can select a search query suggestion for use as a search query, e.g., an alternative to the input search query. The quality of the search query suggestions can depend on the amount, precision, accuracy, and relevancy of data that is used to generate the search query suggestions.

### SUMMARY

This specification describes technologies relating to generation of search query suggestions, e.g., search query suggestions directed to a particular website.

In general, one aspect of the subject matter described in this specification can be embodied in methods that include the actions of receiving a first set of suggestion data defining custom suggestions for a first website, the first set of suggestion data including one or more first n-grams and one or more second n-grams that each represent a selectable alternative to a first n-gram; generating a suggestion resource, including: indexing the one or more first n-grams; and associating each of the one or more first n-grams with the one or more second n-grams that represent selectable alternatives to the respective first n-gram; storing the suggestion resource in a computer-readable memory; and providing a search query suggestion tool to the first website, the suggestion tool being configured to generate a search query input field for webpages on the first website, receive a query input entered in the search query input field, and request that one or more query suggestions be provided as selectable alternatives to the search query input. Other embodiments of this aspect include corresponding systems, apparatus, and computer program products.

The foregoing and following embodiments can optionally include one or more of the following features. The method further includes receiving a first request for one or more input suggestions from the search query input tool provided to the first website; generating the one or more query suggestions based on a first n-gram identified as being represented by the query input and one or more second n-grams associated with the identified first n-gram; and providing the one or more query suggestions in response to the first request. The one or more query suggestions are generated as characters are entered in the search query input field and before a complete query is submitted for a search.

The method further includes receiving a second set of suggestion data defining custom suggestions for a second website, the second set of suggestion data including one or more third n-grams and one or more fourth n-grams that each represent a selectable alternative to a third n-gram; partitioning the suggestion resource into first and second portions, the first portion being the data generated from the indexing the one or more first n-grams and the associating each of the one or more first n-grams with the one or more second n-grams, the second portion being data generated from: indexing the one or more third n-grams; associating each of the one or more third n-grams with the one or more fourth n-grams that represent selectable alternatives to the respective third n-gram; and storing the second portion in the computer-readable memory; and providing a search query suggestion tool to the second website, the suggestion tool being configured to generate a search query input field for webpages on the second website, receive a query input entered in the search query input field, and request that one or more query suggestions be provided as selectable alternatives to the query input.

The method further includes receiving a first request for one or more input suggestions from the suggestion tool provided to the first website; generating the one or more query suggestions based on a first n-gram identified as being represented by the query input and one or more second n-grams associated with the identified first n-gram; providing the one or more query suggestions in response to the first request; receiving a second request for one or more input suggestions from the suggestion tool provided to the second website; generating the one or more query suggestions based on a third n-gram identified as being represented by the query input and one or more fourth n-grams associated with the identified third n-gram; and providing the one or more query suggestions in response to the second request.

The method further includes associating the first portion of the suggestion resource with a first identifier; and associating the second portion of the suggestion resource with a second identifier; where the search query suggestion tool provided to the first website is configured to include the first identifier with the first request; the search query suggestion tool provided to the second website is configured to include the second identifier with the second request; generating the one or more query suggestions based on the first n-gram includes determining that the first identifier of the first requests matches the first identifier associated with the first portion and in response using the first portion of the suggestion resource for generating the one or more query suggestions; and generating the one or more query suggestions based on the third n-gram includes determining that the second identifier of the second requests matches the second identifier associated with the second portion and in response using the second portion of the suggestion resource for generating the one or more query suggestions.

The suggestion tool is plug-in software for each of the pages of the website. The suggestion data includes associations between first n-grams and second n-grams, each association indicating that a second n-gram is a selectable alternative of an associated first n-gram. The input suggestions are query expansions.

Particular embodiments of the subject matter described in this specification can be implemented to realize one or more of the following advantages. Providing custom suggestions reduces how much user interaction is required to obtain suggestions for an input search query and perform searches using one or more of the suggestions. In addition to saving time, providing custom suggestions can increase the precision, accuracy, and coverage of searches by refining a query before the query is submitted and capturing suggestions that are directed to, e.g., particularly relevant to, a particular website or webpage.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram illustrating an example of a flow of data in some implementations of a system that generates a suggestion resource.

FIG. 1B is a block diagram illustrating an example of a flow of data in some implementations of a system that generates input suggestions.

FIG. 1C is a block diagram of an example suggestion server.

FIG. 2 is a block diagram of an example suggestion resource.

FIG. 3 is a screenshot illustrating an example of a webpage presenting a group of input suggestions.

FIG. 4A is a flow chart showing an example process for generating a suggestion tool.

FIG. 4B is a flow chart showing an example process for generating another suggestion tool.

FIG. 5 is a flow chart showing an example process for generating input suggestions.

Like reference numbers and designations in the various drawings indicate like elements.

### DETAILED DESCRIPTION

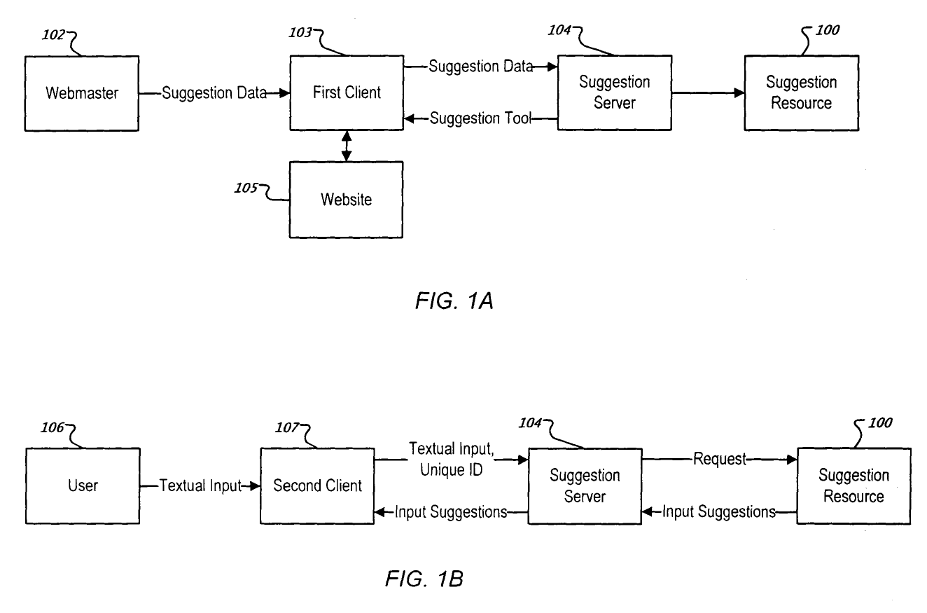

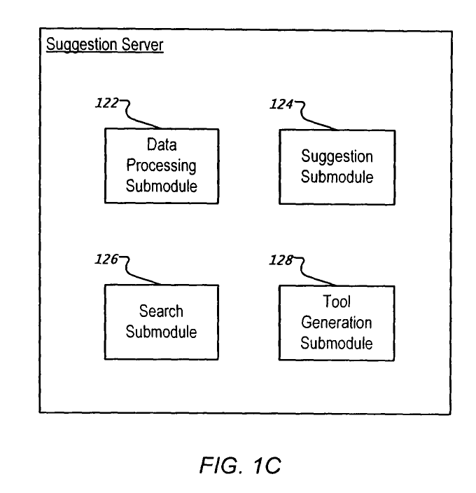

FIG. 1A is a block diagram illustrating an example of a flow of data in some implementations of a system that generates a suggestion resource 100. A webmaster 102 provides a first set of suggestion data to a first client 103. The first client 103 sends to a suggestion server 104 the first set of suggestion data. The suggestion data includes one or more first n-grams and one or more second n-grams.

An n-gram is a sequence of n consecutive tokens, e.g., characters or words. An n-gram has an order, which is a number of tokens in the n-gram. For example, a 1-gram (or unigram) includes one token; a 2-gram (or bi-gram) includes two tokens. Examples of a 2-gram include “at”, which includes two characters, and “all terrain”, which includes 2 words.

The second n-grams, in the suggestion data, each represent selectable alternatives to a first n-gram. The second n-grams can be referred to as custom suggestions because they are input suggestions that are defined by webmaster 102 for a particular website. For example, the input suggestions can be expansions, completions, or any other n-gram specified by webmaster 102.

Suggestion server 104 receives the suggestion data and automatically generates a suggestion resource 100 from the suggestion data. Suggestion resource 100 is a searchable data structure that stores the first n-grams, second n-grams, and associations between the first n-grams and second n-grams. The associations identify that a particular second n-gram is a selectable alternative, e.g., a custom suggestion, for an associated first n-gram.

In addition, suggestion server 104 generates a suggestion tool for suggestion resource 100, and provides the suggestion tool to first client 103 for webmaster 102, or alternatively to a website 105 that webmaster 102 maintains. The suggestion tool, e.g., a search query suggestion tool, is configured to modify existing search query input fields or generate a search query input field for webpages on the website. The suggestion tool is further configured to receive query input entered in the search query input field and request that one or more custom suggestions be provided as selectable alternatives to the search query input.

FIG. 1B is a block diagram illustrating an example of a flow of data in some implementations of a system that generates input suggestions. A user 106 on a client device, e.g., second client 107, enters query input, e.g., textual input, in a search query input field of a webpage. As user 106 enters the query input, second client 107 sends the query input to suggestion server 104, and suggestion server 104 identifies input suggestions using suggestion resource 100, as described in further detail below.

Suggestion server 104 can provide input suggestions to second client 107 for display to user 106 in real time, i.e., as user 106 is typing characters in the search engine query input field. In some implementations, the search query input field is provided by the suggestion tool. For example, suggestion server 104 can present a first collection of input suggestions associated with a first character typed by user 106, and present a second collection of input suggestions associated with a sequence of the first character and a second character in response to user 106 typing the second character in the sequence.

In some implementations, the first set of suggestion data defines a complete set of custom suggestions for the website. In other words, the first set of suggestion data includes all the suggestions defined by webmaster 102 for the website. Other implementations are possible. For example, suggestion server 104 can receive more than one set of suggestion data. Each set of suggestion data is provided for a different website and used to generate a different partition or portion of suggestion resource 100.

In these and other implementations, the suggestion tool also provides to suggestion server 104 an identifier in addition to the query. The identifier can be a unique identifier that indicates the source of the request for input suggestions, e.g., the website or webpage in which the query input was entered by user 106. In some implementations, the identifier is a Uniform Resource Identifier (URI), e.g., a Uniform Resource Locator (URL). The different partitions or portions of suggestion resource 100 can each be associated with the unique identifier that indicates that the partition or portion was generated using suggestion data provided for the website identified by the unique identifier.

In some implementations, the suggestions are a group of second n-grams that are not further organized in a particular hierarchy or classification. For example, webmaster 102 can provide suggestion data that includes a first n-gram “food”. The suggestion data can further include second n-grams, i.e., custom suggestions for the first n-gram “food”, including “salad”, “vegetable soup”, “fajita”, and “meatloaf”.

In alternative implementations, the second n-grams are organized into hierarchies or classifications, e.g., properties. The second n-grams can be associated with properties that are related to the first n-gram. Returning to the previous example, properties of the first n-gram can, for example, include (1) course and (2) cuisine. The custom suggestions “salad” and “vegetable soup” could be associated with the property “appetizer”. The custom suggestions “fajita” and “meatloaf” could be associated with the property “entrée”. Furthermore, “fajita” could be associated with the property “Mexican” and “meatloaf” could be associated with the property “American”.

The second n-grams can be selected as custom suggestions for a particular webpage based on the properties. In particular, webmaster 102 can specify one or more properties from which associated custom suggestions are returned as selectable alternatives. For example, webmaster 102 can be responsible for maintaining a website for different ethnic cultures. The website can include a webpage about Mexican culture and a different webpage about American culture. Webmaster 102 can select the property “Mexican” for the webpage about Mexican culture and the property “American” for the webpage about American culture. Accordingly, if a user enters “foo” in a search query input field on the webpage about Mexican culture, the custom suggestion “fajita” can be returned, e.g., as a selectable alternative to “food”. If a user enters “foo” in a search query input field on the webpage about American culture, the custom suggestion “meatloaf” can be returned, e.g., as a selectable alternative to “food”.

As another example, if a user enters “foo” in a search query input field on the webpage about Mexican culture, the custom suggestion “soccer” can be returned, e.g., as a selectable alternative to “football”. If a user enters “foo” in a search query input field on the webpage about American culture, the custom suggestion “National Football League” can be returned, e.g., as a selectable alternative to “football”.

As another example, webmaster 102 can be responsible for maintaining a website for alumni of a school. The custom suggestions can be classified according to properties including home address, email address, and telephone number. Second n-grams associated with the properties home address, email address, and telephone number would be particular home addresses, email addresses, and telephone numbers, respectively, of alumni members. Different groups of custom suggestions can be returned depending on the one or more properties specified for a particular webpage on the website for alumni of a school. For example, if webmaster 102 specified the properties email address and telephone number for a webpage, and a user entered “Da” in a search query input field on the webpage, then email addresses and telephone numbers for “David”, “Dan”, and “John Davis” can be returned as custom suggestions.

FIG. 1C is a block diagram of an example suggestion server, e.g., suggestion server 104. The suggestion server includes a data processing submodule 122, a suggestion submodule 124, a search submodule 126, and a tool generation submodule 128.

Data processing submodule 122 parses data received by the suggestion server. In some implementations, webmasters provide formatted suggestion data. Example formats of the suggestion data include Extensible Markup Language (XML), JavaScript Object Notation (JSON), line-by-line, and protocol buffers. A protocol buffer is a language and platform neutral, extensible technique for serializing structured data, e.g., by encoding structured data according to Google's data interchange format, Protocol Buffers.

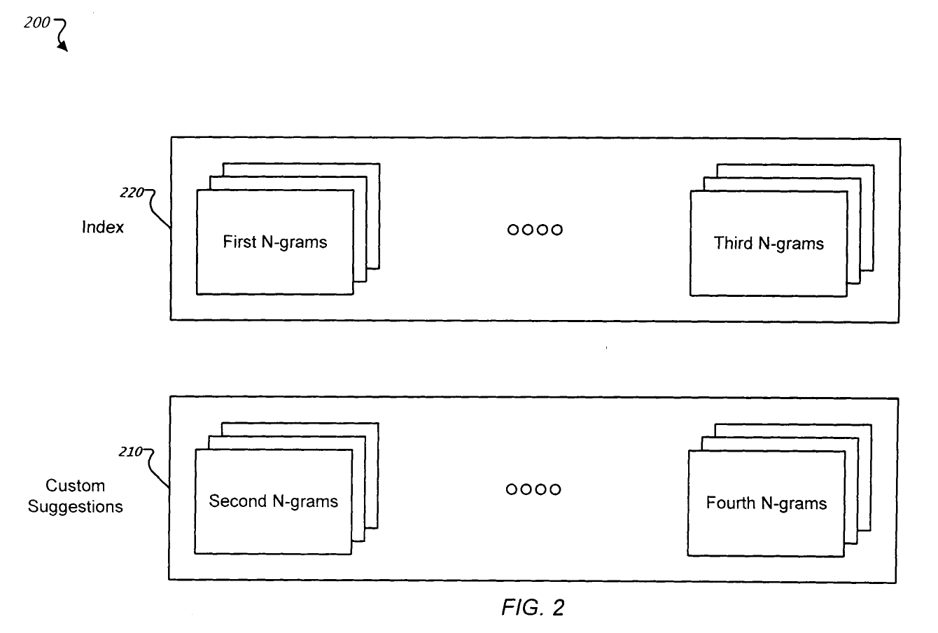

Data processing submodule 122 parses the formatted suggestion data to identify the first n-grams and the second n-grams that are associated with each first n-gram and that represent a selectable alternative to an associated first n-gram. Data processing submodule 122 can send the processed suggestion data to suggestion submodule 124, and suggestion submodule 124 can generate a suggestion resource, as described in further detail below with respect to FIG. 2.

Tool generation submodule 128 can generate a suggestion tool. In some implementations, the suggestion tool is plug-in software, e.g., a JavaScript application programming interface (API), that can be installed on a website. Upon installation on a webpage of a website, the suggestion tool can provide a search query input field that receives a query input and requests one or more query suggestions be provided as selectable alternatives to the search query input.

Data processing submodule 122 can also process requests from suggestion tools. Data processing submodule 122 processes a query input to provide the query input in real time or “near” real time, e.g., after a predetermined period of after no further input is received, to search submodule 126. In implementations where a request from a suggestion tool includes a unique identifier (e.g., a Uniform Resource Locator (URL) of the webpage or website from which the request was sent), data processing submodule 122 parses the identifier and provides the identifier to search submodule 126. Search submodule 126 uses the identifier to identify a partition of a suggestion resource that should be searched, e.g., according to a row key generated based on the identifier.

Search submodule 126 and suggestion submodule 124 can use conventional autocomplete techniques, e.g., prefix matching, midfix matching, suffix matching, highlight matching, and locale feature matching, to identify n-grams that the query input may represent. In some implementations, selectable alternatives are identified only from custom suggestions specified by a webmaster for a particular website, e.g., by directly comparing the query to the custom suggestions. In some alternative implementations, custom suggestions can be used to augment the conventional autocomplete techniques. For example, a conventional autocomplete technique can be used to identify n-grams that the query may represent. Then, search submodule 126 can identify, from a suggestion resource, custom suggestions for the n-grams that the query input may represent, as described in further detail below with respect to FIG. 2.

FIG. 2 is a block diagram of an example suggestion resource. In some implementations, a suggestion resource can be represented by a first data structure 210 (e.g., a database) that includes multiple rows that are indexed by a row key.

In particular, each row can be represented by a protocol buffer. A row key can be a query input (e.g., a first n-gram or third n-gram) indexed by a hash technique, for example. Each row corresponds to a set of n-grams (e.g., second n-grams and fourth n-grams) that represent selectable alternatives to a query input (e.g., a first n-gram or a third n-gram) for a website. The sets of n-grams can be further classified into subsets that correspond to hierarchies or properties.

A second data structure 220(e.g., another database) is used as an index for one or more first data structures (e.g., data structure 200). Second data structure 220 can be used to “reverse map” a unigram (e.g., a term from an observed sequence of terms in the query input) to one or more row keys of one or more first data structures. Second data structure 220 can be a table of cells that is indexed by unigrams in an n-gram. Each cell can include a protocol buffer that includes one or more row keys that identify sets of n-grams in the one or more first data structures. In some implementations, each cell also includes scope information that defines the scope of a search (e.g., data hierarchies or properties that should be searched).

Returning to the previous example where webmaster 102 is responsible for maintaining a website for alumni of a school, the second data structure can include a group of n-grams (e.g., first n-grams) that corresponds to the sequence of characters “Da”. The protocol buffer for the group can include row keys that identify sets of n-grams (e.g., second n-grams) in first data structure 210. For example, the protocol buffer for the group of n-grams that corresponds to “Da” can include a first row key for a set of n-grams in the first data structure for “David”, a second row key for a set of n-grams in the first data structure for “Dan”, and a third row key for a set of n-grams in the first data structure for “John Davis”.

A set of n-grams in the first data structure associated with the first row key can include a cell phone number, an office phone number, a residence address, and an office address for “David”. Another set of n-grams in the first data structure associated with the second row key can include a cell phone number, an office phone number, a residence address, and an office address for “Dan”. Another set of n-grams in the first data structure associated with the third row key can include a cell phone number, an office phone number, a residence address, and an office address for “John Davis”.

Webmaster 102 can provide to the suggestion server 104 suggestion data that includes second n-grams, e.g., a cell phone number, an office phone number, a residence address, and an office address for each of the first n-grams “David”, “Dan”, and “John Davis”. The respective cell phone numbers, office phone numbers, residence addresses, and office addresses are examples of custom suggestions for the n-grams “David”, “Dan”, and “John Davis”, and represent selectable alternatives to “David”, “Dan”, and “John Davis”.

Data processing submodule 122 parses the suggestion data to identify the first n-grams as being “David”, “Dan”, and “John Davis”, and the second n-grams as being the respective cell phone numbers, office phone numbers, residence addresses, and office addresses. Data processing submodule 122 sends the processed suggestion data to suggestion submodule 124, and suggestion submodule 124 generates the suggestion resource, e.g., the first data structure and the second data structure, using the processed suggestion data.

In particular, the suggestion submodule 124 indexes the first n-grams according to row keys and associates each of the one or more first n-grams with the one or more second n-grams that represent selectable alternatives to the respective first n-gram. Tool generation submodule 128 generates a suggestion tool for accessing the suggestion resource and the suggestion server provides the suggestion tool to a website or a webmaster associated with the website. The suggestion tool can be installed on one or more pages of the website to provide an interface for users to enter query input and receive and select custom suggestions.

If a user enters “Da” in a search query input field on the webpage, then search submodule 126 and suggestion submodule 124 can use conventional autocomplete techniques, to identify n-grams that the query input may represent, e.g., “David” (using prefix matching), “Dan” (using prefix matching), and “John Davis” (using midfix matching) for “Da”. Search submodule 126 can use the identified n-grams to locate row keys in second data structure 220 identify custom suggestions, e.g., sets of n-grams in first data structure 210.

If webmaster 102 specified the properties email address and telephone numbers for defining a scope of custom suggestions to be returned for a webpage, and a user entered “Da” in a search query input field on the webpage, then email addresses and telephone numbers (including cell phone numbers and office phone numbers) for “David”, “Dan”, and “John Davis” can be identified from the sets of n-grams in the first data structure and returned as custom suggestions.

Similarly, webmaster 102 or a different webmaster can provide suggestion data for another webpage or website to generate a different portion of suggestion resource 200, e.g., the group of third n-grams and fourth n-grams. N-grams and custom suggestions for the n-grams for each website or webpage can be considered to be stored in different portions of each of the data structures, e.g., first and second data structures 210 and 220. In particular, the row keys can be a hash of the query input and the identifier, e.g., the particular website or webpage from which the query input was obtained. Accordingly, only custom suggestions directed to the particular webpage or website are identified and returned as selectable alternatives to the query input. In some implementations, another suggestion tool can also be generated.

Consolidating custom suggestions for different websites and webpages, in this manner, increases the efficiency of generating and providing selectable alternatives for search queries. In particular, a single service provided by suggestion server 104 and suggestion resource 100 can store and retrieve custom suggestions directed to a particular website or webpage from a collection of custom suggestions for different websites and webpages by using the identifiers that indicate a source of a request, i.e., the particular website or webpage from which the request for custom suggestions originated.

Other implementations are possible. For example, other types of data structures (e.g., linear and non-linear data structures) can be used to store the suggestion resource. In addition, in some implementations, a single data structure (e.g., one database) is used to store the information instead of a separate first data structure and second data structure. In some implementations, only the first data structure is generated and a binary search can be used to search the first data structure to identify custom suggestions. In other words, an access table, e.g., the second data structure, is not generated. In some implementations, a different suggestion resource is generated for each webpage or website.

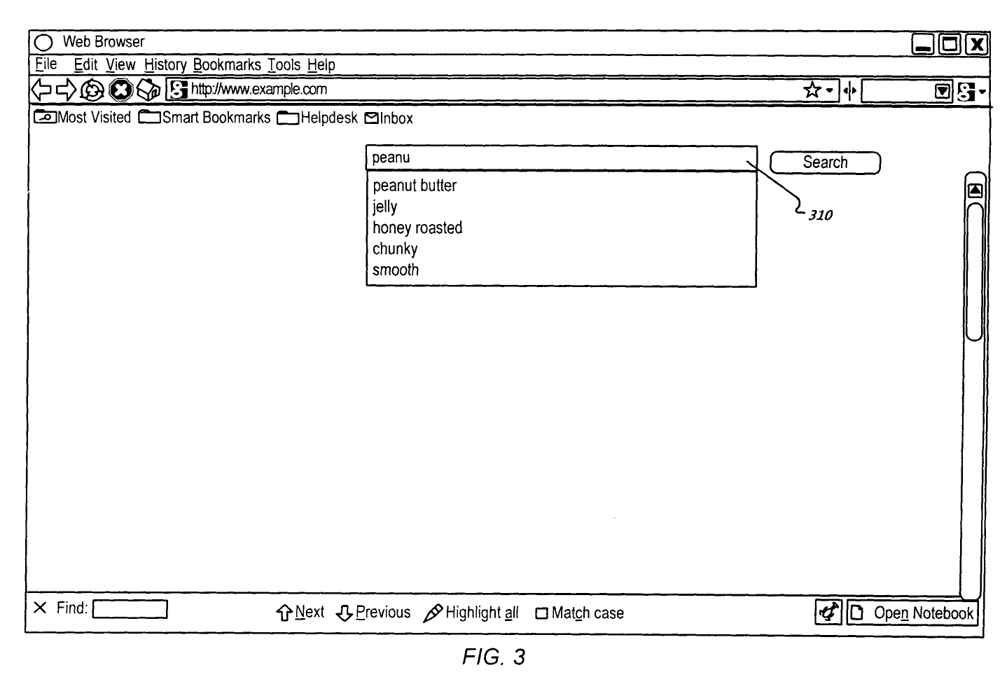

FIG. 3 is a screenshot illustrating an example of a webpage presenting a group of input suggestions. In particular, a suggestion tool is installed on the webpage. The suggestion tool can generate a query input field (e.g., query input field 310) or modify the query input field 310 (e.g., an existing input field) such that custom suggestions are provided in response to textual input, e.g., the sequence of characters “pb”, entered in the query input field 310 by a user. In the example of FIG. 3, the custom suggestions for “peanu” are “peanut butter”, “jelly”, “honey roasted”, “chunky”, and “smooth”. In particular, “jelly”, “honey roasted”, “chunky”, and “smooth” can be custom suggestions specified in suggestion data for the webpage. In addition, “peanut butter” can be an input suggestion obtained from a conventional search service, e.g., a conventional suggestion service provided by a search engine.

In some implementations, the custom suggestions can be presented to the user based on a ranking. The webmaster can specify rankings of each custom suggestion in the suggestion data. Optionally the ranking can be based on a separate authority ranking that measures the importance of each custom suggestion relative to other custom suggestions. In some implementations, the scores are computed from dot products of feature vectors corresponding to a query and a custom suggestion, and the ranking of the custom suggestions is based on relevance scores. The custom suggestions can be ordered according to the rankings and provided to the user according to the order.

Other implementations are possible. For example, suggestion server can create a suggestion management tool, e.g., a dashboard, that can provide statistics of users and facilitate modification of the suggestion resources, e.g., add, delete, change the suggestion resource.

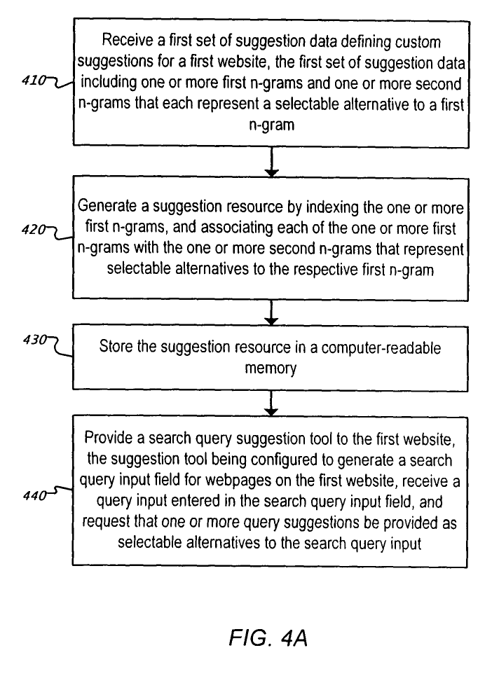

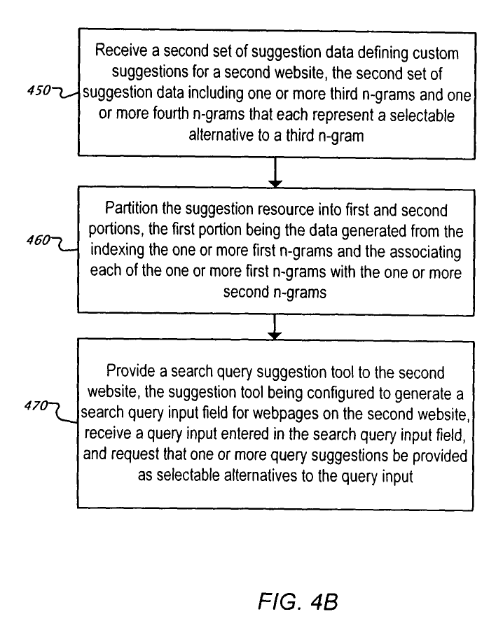

FIG. 4A is a flow chart showing an example process for generating a suggestion tool. The process can be implemented in the suggestion server 104. The process includes receiving a first set of suggestion data defining custom suggestions for a first website, the first set of suggestion data including one or more first n-grams and one or more second n-grams that each represent a selectable alternative to a first n-gram (410). The process also includes generating a suggestion resource by indexing the one or more first n-grams, and associating each of the one or more first n-grams with the one or more second n-grams that represent selectable alternatives to the respective first n-gram (420). The process also includes storing the suggestion resource in a computer-readable memory (430). Furthermore, the process includes providing a search query suggestion tool to the first website, the suggestion tool being configured to generate a search query input field for webpages on the first website and that receives a query input entered in the search query input field and requests for one or more query suggestions be provided as selectable alternatives to the search query input (440).

FIG. 4B is a flow chart showing an example process for generating another suggestion tool. The process can be implemented in the suggestion server 104. In particular, the process for generating another suggestion tool can be performed after the process described with respect to FIG. 4A. The process for generating another suggestion tool includes receiving a second set of suggestion data defining custom suggestions for a second website, the second set of suggestion data including one or more third n-grams and one or more fourth n-grams that each represent a selectable alternative to a third n-gram (450). The process also includes partitioning the suggestion resource into first and second portions (460). The first portion can be generated from the data generated from the indexing the one or more first n-grams and the associating each of the one or more first n-grams with the one or more second n-grams. The second portion of data can be generated from indexing the one or more third n-grams, and associating each of the one or more third n-grams with the one or more fourth n-grams that represent selectable alternatives to the respective third n-gram. The process also includes providing a search query suggestion tool to the second website, the suggestion tool being configured to generate a search query input field for webpages on the second website, receive a query input entered in the search query input field, and request that one or more query suggestions be provided as selectable alternatives to the query input (470).

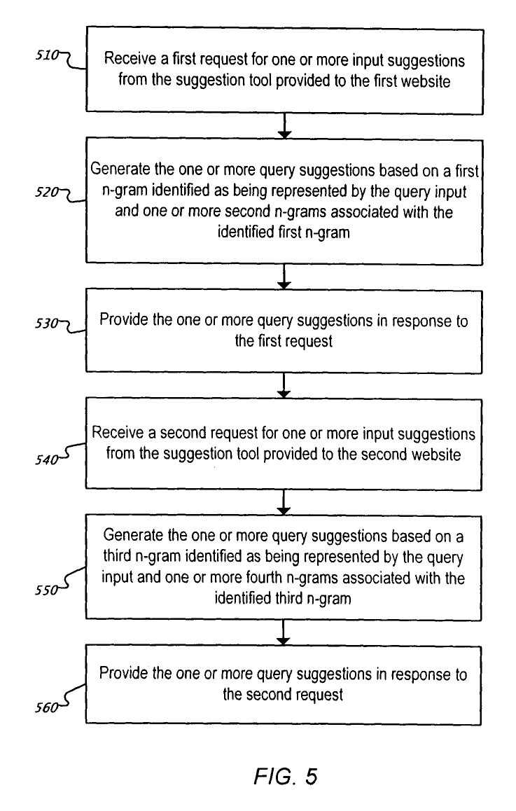

FIG. 5 is a flow chart showing an example process for generating input suggestions. The process can be implemented in the suggestion server 104. In particular, the process for generating input suggestions can be performed after the process described with respect to FIG. 4B. The process for generating input suggestions includes receiving a first request for one or more input suggestions from the suggestion tool provided to the first website (510). The process also includes generating the one or more query suggestions based on a first n-gram identified as being represented by the query input and one or more second n-grams associated with the identified first n-gram (520). The process also includes providing the one or more query suggestions in response to the first request (530). The process also includes receiving a second request for one or more input suggestions from the suggestion tool provided to the second website (540). The process also includes generating the one or more query suggestions based on a third n-gram identified as being represented by the query input and one or more fourth n-grams associated with the identified third n-gram (550), and providing the one or more query suggestions in response to the second request (560).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a first set of suggestion data defining custom suggestions for a first website, the first set of suggestion data including one or more first n-grams and one or more second n-grams that each represent a selectable alternative to a first n-gram;
generating a suggestion resource, including:
indexing the one or more first n-grams; and
associating each of the one or more first n-grams with the one or more second n-grams that represent selectable alternatives to the respective first n-gram;
storing the suggestion resource in a computer-readable memory; and
providing a search query suggestion tool to the first website, the suggestion tool being configured to generate a search query input field for webpages on the first website, receive a query input entered in the search query input field, and request that one or more query suggestions be provided as selectable alternatives to the search query input.

2. The method of claim 1, further comprising:
receiving a first request for one or more input suggestions from the search query input tool provided to the first website;
generating the one or more query suggestions based on a first n-gram identified as being represented by the query input and one or more second n-grams associated with the identified first n-gram; and
providing the one or more query suggestions in response to the first request.

3. The method of claim 2, wherein the one or more query suggestions are generated as characters are entered in the search query input field and before a complete query is submitted for a search.

4. The method of claim 1, further comprising:
receiving a second set of suggestion data defining custom suggestions for a second website, the second set of suggestion data including one or more third n-grams and one or more fourth n-grams that each represent a selectable alternative to a third n-gram;
partitioning the suggestion resource into first and second portions, the first portion being the data generated from the indexing the one or more first n-grams and the associating each of the one or more first n-grams with the one or more second n-grams, the second portion being data generated from:
indexing the one or more third n-grams;
associating each of the one or more third n-grams with the one or more fourth n-grams that represent selectable alternatives to the respective third n-gram; and
storing the second portion in the computer-readable memory; and
providing a search query suggestion tool to the second website, the suggestion tool being configured to generate a search query input field for webpages on the second website, receive a query input entered in the search query input field, and request that one or more query suggestions be provided as selectable alternatives to the query input.

5. The method of claim 4, further comprising:
receiving a first request for one or more input suggestions from the suggestion tool provided to the first website;
generating the one or more query suggestions based on a first n-gram identified as being represented by the query input and one or more second n-grams associated with the identified first n-gram;
providing the one or more query suggestions in response to the first request;
receiving a second request for one or more input suggestions from the suggestion tool provided to the second website;
generating the one or more query suggestions based on a third n-gram identified as being represented by the query input and one or more fourth n-grams associated with the identified third n-gram; and
providing the one or more query suggestions in response to the second request.

6. The method of claim 5, further comprising:
associating the first portion of the suggestion resource with a first identifier; and
associating the second portion of the suggestion resource with a second identifier;
wherein:
the search query suggestion tool provided to the first website is configured to include the first identifier with the first request;
the search query suggestion tool provided to the second website is configured to include the second identifier with the second request;
generating the one or more query suggestions based on the first n-gram comprises determining that the first identifier of the first requests matches the first identifier associated with the first portion and in response using the first portion of the suggestion resource for generating the one or more query suggestions; and
generating the one or more query suggestions based on the third n-gram comprises determining that the second identifier of the second requests matches the second identifier associated with the second portion and in response using the second portion of the suggestion resource for generating the one or more query suggestions.

7. The method of claim 1, wherein the suggestion tool is plug-in software for each of the pages of the website.

8. The method of claim 1, wherein the suggestion data includes associations between first n-grams and second n-grams, each association indicating that a second n-gram is a selectable alternative of an associated first n-gram.

9. The method of claim 1, wherein the input suggestions are query expansions.

10. A system comprising:
a machine-readable storage device including a program product; and
one or more processors operable to execute the program product and perform operations comprising:
receiving a first set of suggestion data defining custom suggestions for a first website, the first set of suggestion data including one or more first n-grams and one or more second n-grams that each represent a selectable alternative to a first n-gram;
generating a suggestion resource, including:
indexing the one or more first n-grams; and
associating each of the one or more first n-grams with the one or more second n-grams that represent selectable alternatives to the respective first n-gram;
storing the suggestion resource in a computer-readable memory; and
providing a search query suggestion tool to the first website, the suggestion tool being configured to generate a search query input field for webpages on the first website, receive a query input entered in the search query input field, and request that one or more query suggestions be provided as selectable alternatives to the search query input.

11. The system of claim 10, where the operations further comprise:
receiving a first request for one or more input suggestions from the search query input tool provided to the first website;
generating the one or more query suggestions based on a first n-gram identified as being represented by the query input and one or more second n-grams associated with the identified first n-gram; and
providing the one or more query suggestions in response to the first request.

12. The system of claim 11, wherein the one or more query suggestions are generated as characters are entered in the search query input field and before a complete query is submitted for a search.

13. The system of claim 10, where the operations further comprise:
receiving a second set of suggestion data defining custom suggestions for a second website, the second set of suggestion data including one or more third n-grams and one or more fourth n-grams that each represent a selectable alternative to a third n-gram;
partitioning the suggestion resource into first and second portions, the first portion being the data generated from the indexing the one or more first n-grams and the associating each of the one or more first n-grams with the one or more second n-grams, the second portion being data generated from:
indexing the one or more third n-grams;
associating each of the one or more third n-grams with the one or more fourth n-grams that represent selectable alternatives to the respective third n-gram; and
storing the second portion in the computer-readable memory; and
providing a search query suggestion tool to the second website, the suggestion tool being configured to generate a search query input field for webpages on the second web site, receive a query input entered in the search query input field, and request that one or more query suggestions be provided as selectable alternatives to the query input.

14. The system of claim 13, where the operations further comprise:
receiving a first request for one or more input suggestions from the suggestion tool provided to the first website;
generating the one or more query suggestions based on a first n-gram identified as being represented by the query input and one or more second n-grams associated with the identified first n-gram;
providing the one or more query suggestions in response to the first request;
receiving a second request for one or more input suggestions from the suggestion tool provided to the second website;
generating the one or more query suggestions based on a third n-gram identified as being represented by the query input and one or more fourth n-grams associated with the identified third n-gram; and
providing the one or more query suggestions in response to the second request.

15. The system of claim 14, where the operations further comprise:
associating the first portion of the suggestion resource with a first identifier; and
associating the second portion of the suggestion resource with a second identifier;
wherein:
the search query suggestion tool provided to the first website is configured to include the first identifier with the first request;
the search query suggestion tool provided to the second website is configured to include the second identifier with the second request;
generating the one or more query suggestions based on the first n-gram comprises determining that the first identifier of the first requests matches the first identifier associated with the first portion and in response using the first portion of the suggestion resource for generating the one or more query suggestions; and
generating the one or more query suggestions based on the third n-gram comprises determining that the second identifier of the second requests matches the second identifier associated with the second portion and in response using the second portion of the suggestion resource for generating the one or more query suggestions.

16. The system of claim 10, wherein the suggestion tool is plug-in software for each of the pages of the website.

17. The system of claim 10, wherein the suggestion data includes associations between first n-grams and second n-grams, each association indicating that a second n-gram is a selectable alternative of an associated first n-gram.

18. The system of claim 10, wherein the input suggestions are query expansions.

19. A computer program product, stored on a computer-readable medium, operable to cause data processing apparatus to perform operations comprising:
receiving a first set of suggestion data defining custom suggestions for a first website, the first set of suggestion data including one or more first n-grams and one or more second n-grams that each represent a selectable alternative to a first n-gram;
generating a suggestion resource, including:
indexing the one or more first n-grams; and
associating each of the one or more first n-grams with the one or more second n-grams that represent selectable alternatives to the respective first n-gram;
storing the suggestion resource in a computer-readable memory; and
providing a search query suggestion tool to the first website, the suggestion tool being configured to generate a search query input field for webpages on the first website, receive a query input entered in the search query input field, and request that one or more query suggestions be provided as selectable alternatives to the search query input.
